(19) United States
(12) Patent Application Publication
(10) Pub. No.: US 2006/0293801 A1
(43) Pub. Date: Dec. 28, 2006

(54) Method for measuring the length variation of a spring, and spring with corresponding sensor

(75) Inventor: Mauro Del Monte, Modena (IT)

Correspondence Address: MODIANO & ASSOCIATI, Via Meravigli, 16, MILAN, 20123, IT

(73) Assignee: M.D. MICRO DETECTORS S.P.A.

(21) Appl. No.: 11/480,357

(22) Filed: Jul. 5, 2006

(30) Foreign Application Priority Data
Apr. 8, 2005 (IT) MO2005A000085

(51) Int. Cl. G05D 1/00

(52) U.S. Cl. 701/2

(57) ABSTRACT

A method for measuring a length variation of a spring, comprising the steps of: associating a sensor element with a spring; determining an impedance measurement of the sensor element; on the basis of the impedance measurement, determining the length variation of the spring.

The present invention relates to a method for measuring the length variation of a spring and to a spring with a corresponding sensor. More particularly, the invention relates to a method for measuring the elongation of a spring, a measurement which can be used to monitor the vibrations of an object connected to the spring, in order to measure forces indirectly or to calculate a position.

The invention also relates to a spring with the corresponding sensor, which allows to perform the elongation measurement described above.

### BACKGROUND OF THE INVENTION

As it is known, there is a displacement sensor of the inductive type which uses the LVDT principles and consists of a primary coil and two secondary coils with a common movable magnetic core.

Sensors of the LVDT type are composed substantially of a fixed part and a movable part, which must be anchored to the two ends of the spring or in any case to two separate points thereof. Measurement of the elongation is determined indirectly by measuring the relative position of the two parts of the sensor. With a similar technique, it is also possible to provide capacitive sensors.

Other sensors that can be used for this purpose are load cells, which measure the load to which the spring is subjected. This information is then processed in order to determine the extent of the elongation. In order to be able to measure the force applied by the spring, the cell must be connected between a fixed point and an end of the spring or between the two ends of the spring.

Although these types of sensor can be applied to measuring the elongation of a spring, they require the use of two anchoring points, at least one of which belongs to the spring body.

### SUMMARY OF THE INVENTION

The aim of the present invention is to provide a device for measuring the length variation of a spring which allows to determine reliably the elongation or contraction undergone by the spring with respect to a known static situation.

Within this aim, an object of the present invention is to provide a device for measuring the length variation of a spring when stressed which allows to provide a precise measurement of the elongation or contraction of the spring.

Another object of the present invention is to provide a device for measuring the length variation of a spring in which the sensor element is connected directly to the spring at only one of its ends, or in any case to a single point thereof.

Another object of the present invention is to provide a device for measuring the length variation of a spring in which the sensor can be provided simultaneously with the spring or can be applied at a later time to the spring.

Another object of the present invention is to provide a method for measuring the length variation of a spring and a corresponding sensor which are highly reliable, relatively simple to provide and at competitive costs.

This aim and these and other objects, which will become better apparent hereinafter, are achieved by a method for measuring a length variation of a spring, comprising the steps of:

associating a sensor element with a spring;

determining an impedance measurement of said sensor element;

on the basis of said impedance measurement, determining a length variation of said spring.

### BRIEF DESCRIPTION OF THE DRAWINGS

Further characteristics and advantages of the invention will become better apparent from the following detailed description of preferred but not exclusive embodiments of the method and the device according to the present invention, illustrated by way of non-limiting example in the accompanying drawings, wherein:

FIG. 1 is a view of a first embodiment of a spring with a sensor according to the present invention;

FIG. 2 is a view of a second embodiment of a spring with a sensor according to the present invention;

FIG. 3 is a schematic view of a spring with a sensor according to the first embodiment according to the present invention, shown in the traction condition;

FIG. 4 is a block diagram of the principle on which the measurement method according to the present invention is based; and

FIG. 5 is a circuit diagram of a sensor of the inductive type.

### DESCRIPTION OF THE PREFERRED EMBODIMENTS

With reference to the figures, a method and a corresponding sensor for measuring the length variation of a spring are as follows.

In particular, with reference to FIG. 1, a first embodiment is shown of a sensor of the inductive type, which is applied to a spring, made of a material of the paramagnetic type, in order to measure its length variation both during elongation and during contraction.

Conveniently, the reference numeral 1 designates a metallic spring, while the reference numeral 2 designates the sensor, for example a solenoid, which is accommodated inside the spring or can be arranged outside it. A current is circulated in the solenoid, which generates a magnetic field which is approximately uniform within said solenoid and has a distribution, on the outside of the solenoid, which follows specific lines of force.

The energy accumulated by the system through the magnetic field naturally tends to a minimum, and therefore the lines of the magnetic field tend to concentrate in the regions where a material with higher permeability (i.e., the material of which the turns of the springs are constituted) is present, and to become less concentrated where said turns are not present.

When the spring is inactive, the lines of the magnetic field outside the solenoid are closer, since the path through the high-permeability material is substantially continuous. In this case, the magnetic circuit has minimum reluctance, and accordingly the value of the inductance across the solenoid is at its maximum.

Likewise, when the spring is extended, the magnetic circuit comprises the air gaps between one turn and the next and therefore follows a path with greater reluctance, with a consequent reduction of inductance across the solenoid.

The DC circuit model of the solenoid is constituted by an inductor, the value of which depends on the elongation of the spring, and by a parallel resistor, which represents the energy losses due to the conductivity of the winding of the solenoid.

If the solenoid is used with AC, the remarks made for the distribution of the magnetic field (which is now alternating) on the outside of the solenoid and for the inductance across it still apply as a first approximation. A new form of energy dissipation is instead introduced which is due to the currents induced in the metallic material that constitutes the spring. The equivalent AC circuit, across the solenoid, now comprises a second resistor in parallel, which indeed takes into account this power dissipation.

A measurement of the impedance across the solenoid therefore yields as a result a dipole formed by an inductor and a resistor in parallel, the values of which are a function of the elongation of the spring.

A dipole with these characteristics is usually described by an inductance value L and by a quality factor Q, which in the case of parallel modeling is defined as
Q=Rₚ/ωL

where R_{P} is the value of the parallel resistance, L is the value of the inductance and ω is the pulse rate at which the measurement is made. When the spring is inactive, the inductance has the maximum value and the resistance has the minimum value, and therefore the quality factor Q assumes the lowest value. When the spring is extended, the value of R_{P} increases monotonically and the value of L decreases monotonically, and therefore a monotonic rise of the value of Q occurs.

A similar reasoning can be made if the equivalent dipole is modeled as a series dipole. In this case, the resistance R_{S} would increase in value as the losses increase and therefore would decrease as the extension of the spring increases. The quality factor in this case is defined as
Q=ωL/R_{S}
where both L and R_{S} are decreasing monotonic functions of the extension of the spring.

Although in this case it is not evident, there is also a monotonic increase in the quality factor, since its definition reflects a property of the impedance across the dipole, regardless of how it is modeled (the quality factor Q of the series model must necessarily be equal to the quality factor of the parallel model).

Therefore, any measurement of one or more of the parameters that categorize the impedance across the solenoid (inductance, quality factor, resistance) can be correlated monotonically with the extension of the spring.

The sensor of the inductive type can be applied for springs of the metallic type regardless of the magnetic behavior, since in the equivalent circuit there is always at least the resistive term which models conductivity losses. The description is almost equivalent for springs made of diamagnetic material, except for the fact that in this case the lines of force are repelled (or in any case are not attracted) by the material that constitutes the spring.

FIG. 2 is a view of a second embodiment of the sensor according to the invention, in which the reference numeral 1 again designates the spring, while the reference numeral 2 designates a sensor of the capacitive type, in which a capacitive element is inserted within the spring or is arranged outside it. Such capacitive element is provided by means of a first plate 3 and a second plate 4, which are accommodated within respective guards 5 and 6.

As an alternative, one of the two plates might be constituted by the turns of the spring, if said spring is metallic, or by the ground of the system: the sensing component would be constituted, in such cases, by a single plate and the corresponding guard.

If a potential difference is established between the two plates, an electrical field is generated between said two plates.

In the case of the metallic spring, since the electrical field is nil within a metal, in the case of such a spring, when inactive (for the sake of simplicity it is assumed that the inactive condition is the condition in which the spring is fully compressed), such field occurs only between the plates and the turns of the spring. Where the field is present, the dielectric constant is that of air, while the path is the shortest possible. This situation corresponds to a high capacitance value.

If the spring is extended, some field lines do not pass through the metal and the path increases in length. This situation produces a capacitance value which decreases monotonically as the spring is extended.

In the case instead of a dielectric spring, for reasons similar to the ones already described for the magnetic field, the electrical field lines tend to concentrate in the regions where a material with a higher dielectric constant is present.

In the case of an inactive spring, the electrical field lines pass predominantly through the material of the spring and therefore follow a path with a high dielectric constant. In this case, the capacitance between the plates has a high value. If the spring is extended, part of the path of the electrical field must necessarily be in air, and further the length of the field lines is on average greater. This configuration gives rise to a lower capacitance.

Also in this case, there is a capacitance value which decreases monotonically with the extension of the spring.

The capacitive system also can be modeled with a dipole which is composed of a resistor and a capacitor in series or in parallel. The capacitor represents the capacitance between the electrodes, while the resistor represents the losses due to conductivity of the plates of the capacitor.

If the capacitive system is subjected to an AC voltage, the resistive part of the equivalent dipole takes into account the conductivity losses in the spring, if the spring is metallic, or the dielectric losses, if the spring is dielectric.

Also in this case, it is possible to define a quality factor, defined as
Q=1/ωR_{S}C
in the case of a series model, or Q=ωR_{P}C for the parallel model, where R_{S}, R_{P} and ω are respectively the series equivalent resistance, the parallel equivalent resistance, and the pulse rate at which the measurement is made.

When the spring is inactive, the capacitance is highest, and so are the losses. Therefore, R_{P} assumes the lowest value, while R_{S} assumes the highest value. The expression of the quality factor for the series dipole shows that Q assumes the minimum value.

The extension of the spring entails a reduction in capacitance and losses and therefore an increase in R_{P} and a decrease in R_{S}, therefore a monotonic increase of the quality factor Q. Every measurement of the impedance between the two plates, therefore, can be correlated monotonically with the extension of the spring.

Therefore, the use of a sensor of the inductive or capacitive type combined with a spring, in which the sensor is crossed by a current, allows to obtain a variation of the electrical parameters of the sensor. In the case of an inductor, there is a variation in inductance and losses, whereas in the case of a capacitor, there is a variation in capacitance and losses.

In order to be able to convert the variation of the electrical parameters into a measurement of the variation of the length of the spring, it is necessary to provide an oscillator in which the sensing element is a capacitor C or an inductor L which determines the characteristics (frequency and optionally amplitude) of the oscillation. The sensing element, designated in FIG. 4 by the reference numeral 10, is made so that the lines of the electrical field (if the sensor is capacitive) or the lines of the magnetic field (if the sensor is inductive) generated by it affect the portion of space in which the measurement is to be made, which must comprise at least partly the turns of which the spring is made.

The conceptual diagram is shown in FIG. 4. The reference numeral 11 designates the turns of the spring, the reference numeral 12 designates the lines of the electrical or magnetic field, the reference numeral 13 designates an oscillator, and the reference numeral 14 designates a control circuit.

As already explained earlier, the presence of a metallic material in the magnetic field of the solenoid changes its equivalent resistance (due to the conductivity losses) and possibly also its inductance (if a material has a permeability that is different from that of air). The variation in the unit of parameters is linked by means of a monotonic function to the volume occupied by the material in the field of action of the inductor. In particular, if the volume occupied by the metal is the largest possible (compressed spring), losses due to conductivity and inductance are highest and decrease as the spring extends. The extended condition of the spring can be deduced from the measurement of the energy required by the oscillator in order to sustain the oscillation: such energy is of course higher if the losses are high. This variation in energy requirement can be converted simply into a variation of the current absorbed by the circuit.

If the material of which the spring is made has a magnetic permeability which is significantly different than the given one, the extension of the spring also causes a variation of the inductance value and therefore can also be deduced from the measurement of the frequency of the oscillation.

This kind of reasoning can explain the operation of a capacitive sensor, which this time operates by means of electrical fields, is sensitive to the variation of the dielectric constant (as well as to losses), and has a metallic plate of a capacitor as its sensing element.

The choice of which parameter or parameters of the impedance of the sensor (L, R, C) are to be considered significant for determining the length of the spring depends on the type of sensor chosen (capacitive or inductive) and on the type of material of which the spring is made.

If, for example, the spring is constituted by diamagnetic material and the measurement method is the inductive one, the only significant parameter is the resistance R, since the inductance variations are probably negligible or difficult to detect.

If the spring is made of nonconducting dielectric material and the sensor is a capacitive one, the significant parameter is capacitance, since losses due to conductivity and polarization are difficult to measure.

FIG. 5 illustrates one of the possible circuits used for a sensor of the inductive type, the purpose of which is to measure equivalent resistance (i.e., the quality factor).

In the circuit, power is supplied between two points A and B, and the output voltage of the node OUT is a function of the current absorbed by the oscillator. As can be seen, a thermal compensation network is provided and is represented schematically as a resistor 20, which is designed to render irrelevant the parametric variations of the components of the temperature sensor and thus make the circuit sensitive only to the environment detected by the inductor.

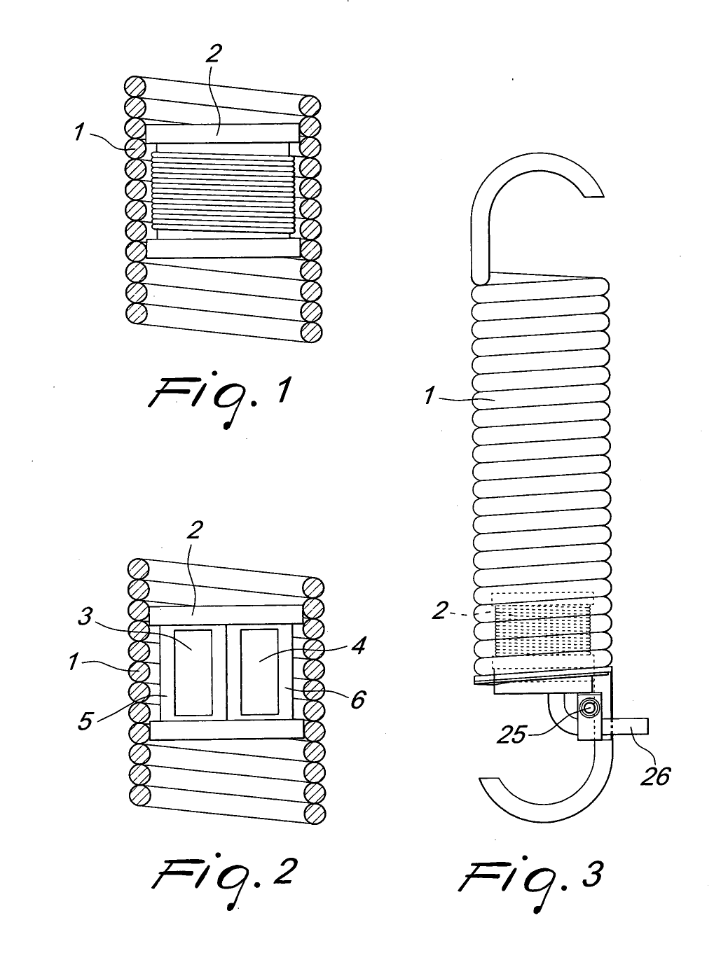

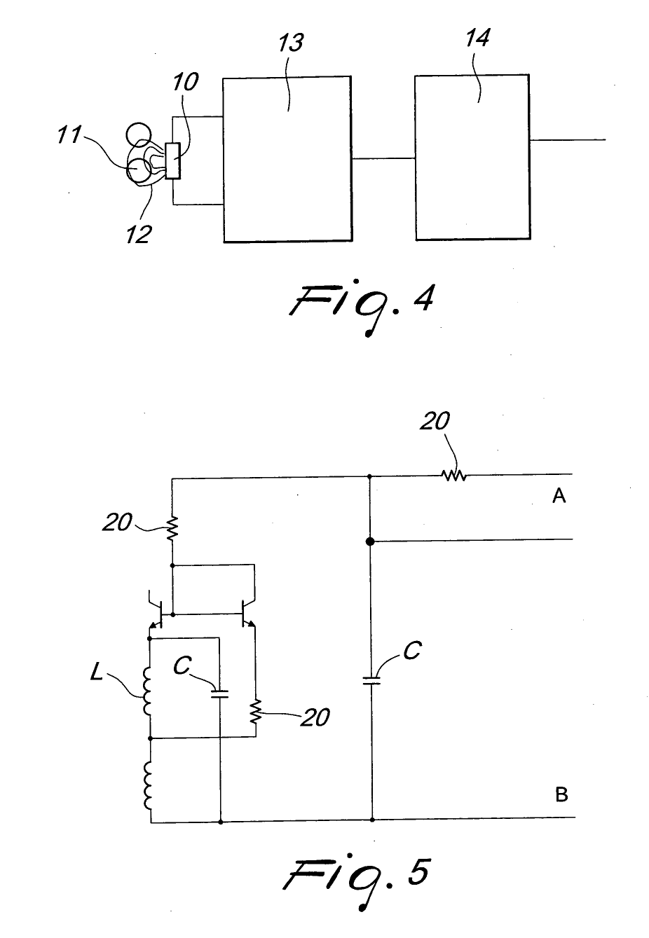

FIG. 3 is a view of a detail of the fixing of the inductive sensor 2, shown in FIG. 1, inside the spring 1. The sensor is fixed by means of a fixing screw 25. FIG. 3 also illustrates the presence of a connecting cable 26 for supplying power to the inductive sensor 2.

In practice it has been found that the method and the sensor device according to the present invention fully achieve the intended aim and objects, since they allow to obtain an indirect measurement of the variation of the length of a spring, on the basis of variations of electrical parameters of an inductor, in the case of an inductive sensor, or of a capacitor, in the case of a capacitive sensor.

In particular, the device allows to determine reliably the elongation or contraction undergone by the spring with respect to a static known situation; the spring might be fitted on the machine so that at rest it is already subjected to a static load and the sensor would be able to assess the length variations with respect to such static situation.

The method and the device thus conceived are susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

What is claimed is:

1. A method for measuring a length variation of a spring, comprising the steps of:
associating a sensor element with a spring;
determining an impedance measurement of said sensor element;
on the basis of said impedance measurement, determining a length variation of said spring.

2. The method of claim 1, wherein said sensor element comprises an inductive sensor which is adapted to be crossed by a current in order to generate a magnetic field.

3. The method of claim 2, wherein said inductive sensor is a solenoid.

4. The method of claim 3, wherein said impedance is the impedance across said solenoid.

5. The method of claim 3, wherein said solenoid can be represented schematically in circuit terms by an inductor, the inductance value of which depends on the elongation or contraction of the spring, and by a resistor in parallel, which represents energy losses.

6. The method of claim 5, wherein said energy losses are due to conductivity of the winding of the solenoid.

7. The method of claim 5, wherein said energy losses are due to conductivity and polarization of the material that constitutes the spring.

8. The method of claim 5, wherein the resistance value of said resistor depends on the elongation or contraction of the spring.

9. The method of claim 3, wherein said solenoid is subjected to an AC voltage.

10. The method of claim 1, wherein said sensor element comprises a capacitive sensor.

11. The method of claim 10, wherein said capacitive sensor is subjected to a potential difference in order to generate an electrical field.

12. The method of claim 10, wherein said capacitive sensor can be represented schematically in circuit terms by means of a dipole composed of a resistor and a capacitor in series or in parallel.

13. The method of claim 12, wherein the values of the resistance and capacitance of said resistor and said capacitor depend on the elongation or contraction of the spring.

14. The method of claim 10, wherein said capacitive sensor is subjected to an AC voltage.

15. The method of claim 1, wherein said sensor element is arranged inside said spring.

16. The method of claim 1, wherein said sensor element is arranged outside said spring.

17. The method of claim 1, wherein said sensor element is anchored to the spring at a single point.

18. The method of claim 17, wherein said sensor element is anchored mechanically to the spring.

19. A spring, comprising a sensor element which allows to detect a length variation of the spring with respect to an inactive condition.

20. The spring of claim 19, wherein said sensor element is arranged inside said spring.

21. The spring of claim 19, wherein said sensor element is arranged outside said spring and around it.

22. The spring of claim 19, wherein said sensor element is an inductive sensor.

23. The spring of claim 19, wherein said sensor element is a capacitive sensor.

24. The spring of claim 19, wherein said spring is made of metallic material.

25. The spring of claim 19, wherein said spring is made of dielectric material.

26. The spring of claim 19, wherein said sensor element is connected to a portion of a turn of said spring.

27. The spring of claim 19, wherein said sensor element is adapted to be crossed by an electric current supplied by means of a power supply cable.
